(19) United States
(12) Patent Application Publication
(10) Pub. No.: US 2025/0119015 A1
(43) Pub. Date: Apr. 10, 2025

(54) COOLING SEPARATORS FOR A WOUND ROTOR

(71) Applicant: BorgWarner Inc., Auburn Hills, MI (US)

(72) Inventors: Josh B. Lahrman, New Palestine, IN (US); Dave A. Fulton, Anderson, IN (US); Kirk Neet, Noblesville, IN (US)

(21) Appl. No.: 18/909,822

(22) Filed: Oct. 8, 2024

Related U.S. Application Data
(60) Provisional application No. 63/588,869, filed on Oct. 9, 2023.

(51) Int. Cl. H02K 3/24; H02K 1/24; H02K 7/04

(52) U.S. Cl. CPC H02K 3/24; H02K 1/24; H02K 7/04

(57) ABSTRACT

An electrical machine includes a wound field rotor. The wound field rotor includes a shaft defining a longitudinal axis, a plurality of laminations mounted to an outer surface of the shaft and including rotor teeth defining an axial channel along the longitudinal axis, a plurality of field windings disposed in the axial channel, and a field separator disposed in the axial channel to secure the plurality of field windings in the axial channel. The field separator includes a post at an axial end of the field separator, the post having a passage therethrough to allow a fluid to flow out of the axial channel and into a side channel at an end of the rotor.

### CROSS REFERENCE TO RELATED APPLICATIONS

This application claims the benefit of an earlier filing date from U.S. Provisional Application Ser. No. 63/588,869 filed Oct. 9, 2023, the entire disclosure of which is incorporated herein by reference.

### BACKGROUND OF THE INVENTION

Exemplary embodiments pertain to the art of electric motors and, more particularly, to a cooling system for an electric machine having a wound field rotor.

During operation, electric motors produce heat. Often times, rotating components of an electric motor may support a fan member that directs a flow of air through internal motor components. The flow of air may help with smaller systems, such as alternators, and systems that are installed in in open areas, such as generators. The flow of air is not always sufficient in high output systems, particularly those installed in closed areas, such as motor vehicle engine compartments.

Electric motors that are employed as prime movers in a motor vehicle typically include a liquid coolant system. The electric motor includes a stator and a rotor. The liquid cooling system may include an inlet that receives coolant and an outlet that guides coolant to a heat exchange system. The coolant may flow in a jacket arranged radially outwardly of a stator of the electric motor. Additional coolant may be directed onto the rotor, or between the rotor and a shaft supporting the rotor.

Cooling external surfaces of the rotor laminations and as well as an interface between the rotor laminations and the shaft is beneficial. However, remaining portions of the rotor also produce heat that can detract from an overall operational efficiency. Accordingly, the industry would be receptive to a cooling system that interacts with internal rotor surfaces as well as rotor winding surfaces to increase operating efficacy.

### BRIEF DESCRIPTION OF THE INVENTION

A wound field rotor, in accordance with a non-limiting example, includes a shaft defining a longitudinal axis, a plurality of laminations mounted to an outer surface of the shaft and including rotor teeth defining an axial channel along the longitudinal axis, a plurality of field windings disposed in the axial channel, and a field separator disposed in the axial channel to secure the plurality of field windings in the axial channel. The field separator includes a post at an axial end of the field separator, the post having a passage therethrough to allow a fluid to flow out of the axial channel and into a side channel at an end of the rotor.

An electrical machine, in accordance with a non-limiting example, includes a stator and a rotor rotatable within the stator. The rotor includes a shaft defining a longitudinal axis, a plurality of laminations mounted to an outer surface of the shaft and including rotor teeth defining an axial channel extending along the longitudinal axis, a plurality of field windings disposed in the axial channel, and a field separator disposed in the axial channel to secure the plurality of field windings in the axial channel. The field separator includes a post at an axial end of the field separator, the post having a passage therethrough to allow a fluid to flow out of the axial channel and into a side channel at an end of the rotor.

A method of operating an electrical machine, in accordance with a non-limiting example, includes flowing a coolant through a rotor of the electric machine. The rotor includes a shaft defining a longitudinal axis, a plurality of laminations mounted to an outer surface of the shaft and including rotor teeth defining an axial channel extending along the longitudinal axis, a plurality of field windings disposed in the axial channel, and a field separator disposed in the axial channel to secure the plurality of field windings in the axial channel. The field separator includes a post at an axial end of the field separator, the post having a passage therethrough to allow the coolant to flow out of the axial channel and into a side channel at an end of the rotor.

### BRIEF DESCRIPTION OF THE DRAWINGS

The following descriptions should not be considered limiting in any way. With reference to the accompanying drawings, like elements are numbered alike:

FIG. 1 depicts a cross-sectional side view of an electric machine including a would field rotor having a cooling system, in accordance with a non-limiting example;

FIG. 2 depicts a cross-sectional axial end view of the wound field rotor of FIG. 1 taken through the lines 2-2;

FIG. 3 depicts a plan view of a rotor lamination of the wound field rotor of FIG. 2;

FIG. 4 depicts a plan view of another rotor lamination of the wound field rotor of FIG. 2;

FIG. 5 depicts a plan view of yet another rotor lamination of the wound field rotor of FIG. 2;

FIG. 6 depicts a plan view of still yet another rotor lamination of the wound field rotor of FIG. 2; and

FIG. 7 depicts a plan view of a winding end turn insulator, in accordance with a non-limiting example.

FIG. 8 is a perspective view of the wound field rotor, in an illustrative embodiment;

FIG. 9 is a perspective view of the rotor of FIG. 8 with balance rings for securing the rotor;

FIG. 10 is a perspective view of the field separator, in an illustrative embodiment;

FIG. 11 shows a longitudinal cross-sectional view of the rotor passes through the field separator;

FIG. 12 shows a perspective view of the cross-section of the rotor, illustrating a flow circuit of coolant fluid through the rotor;

FIG. 13 shows an expanded view of a cross-section of the first post in a first embodiment; and

FIG. 14 shows an expanded view of a cross-section of the first post in a second embodiment.

### DETAILED DESCRIPTION OF THE INVENTION

A detailed description of one or more embodiments of the disclosed apparatus and method are presented herein by way of exemplification and not limitation with reference to the Figures.

An electric machine, in accordance with a non-limiting example, is indicated generally at 10 in FIG. 1. Electric machine 10 includes a housing 12 having an outer surface 14 and an inner surface 16. A stator 20 is fixedly connected to inner surface 16. Stator 20 includes stator windings 22 having a first end turn 24 and a second end turn 26. A wound field rotor 30 is rotatably mounted in housing 12 radially inwardly of stator 20. The wound field rotor 30 is supported on a shaft 32 in housing 12.

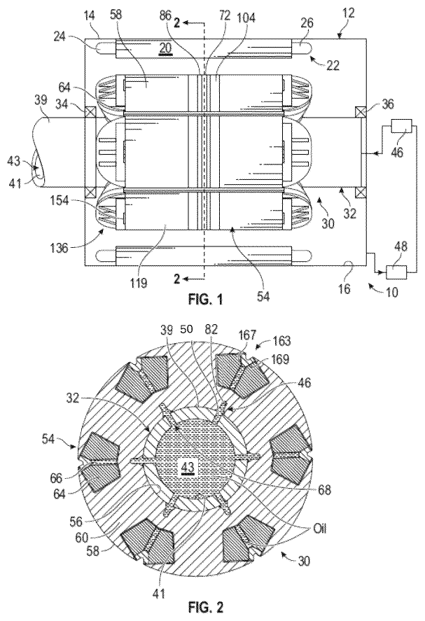

In a non-limiting example, shaft 32 is supported at a first end (not separately labeled) by a first bearing 34 and at a second end (also not separately labeled) by a second bearing 36. Shaft 32 includes an outer surface 39 and an inner surface 41 that defines a coolant flow path 43. Coolant, such as oil, is passed from a coolant supply system 46 through coolant flow path 43, internally through wound field rotor 30 and into housing 12 before passing to a coolant drain system 48. Coolant may flow through a plurality of passages, one of which is indicated at 50 (FIG. 2) that extend through shaft 32.

In a non-limiting example, wound field rotor 30 includes a plurality of laminations 54 having an inner annular surface 56 and a discontinuous outer annular surface 58 that define a plurality of rotor teeth 60. A plurality of field windings 64 are wrapped around each of the plurality of rotor teeth 60. A plurality of channels, one of which is indicated at 66 is defined between adjacent ones of the plurality of field windings 64. As will be detailed herein, plurality of laminations 54 define an internal cooling circuit 68 that is disposed between inner annular surface 56 and discontinuous outer annular surface 58. As will become more fully evident herein, cooling circuit 68 includes a first circuit portion (not separately labeled) that feeds each of channels 66 thereby cooling internal surfaces of field windings 64 and a second circuit portion (also not separately labeled) that extends axially through laminations 54 to cool the wound field rotor 30 internally as well as spray coolant onto first and second stator end turns 24 and 26.

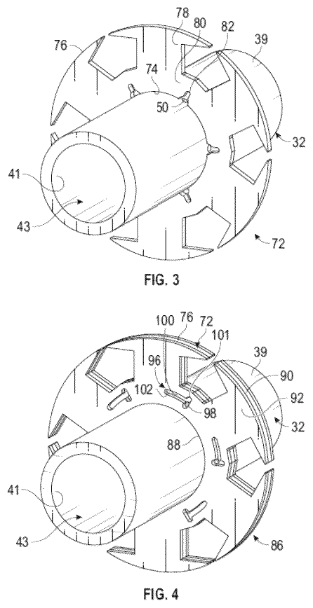

Reference will follow to FIGS. 3-6 with continued reference to FIGS. 1 and 2 in describing different lamination portions of laminations 54. Rotor laminations 54 include a first or central lamination portion(s) 72 (FIG. 3) having a first inner surface portion 74, a first outer surface portion 76 and a first plurality of rotor tooth elements 78 joined by a first web portion 80. A first passage portion 82 extends from first inner surface portion 74 into first web portion 80. First passage portion 82 aligns with passage 50 and defines a coolant inlet. At this point, it should be understood, that a first passage portion is provided at each passage 50.

A second lamination portion 86 is depicted in FIG. 4. Second lamination portion 86 is positioned adjacent to each side of first lamination portion 72. Second lamination portion 86 includes a second inner surface portion 88 and a second outer surface portion 90 that defines a plurality of rotor tooth elements 92. Rotor tooth elements 92 are joined by a second web portion 94. A second passage portion 96 is defined in second web portion 94. Second passage portion 96 includes a first end 98 that extends generally radially along second web portion 94 and a second end 100 that connects with first end 98 and extends circumferentially along second web portion 94. First end 98 registers with first passage portion 82.

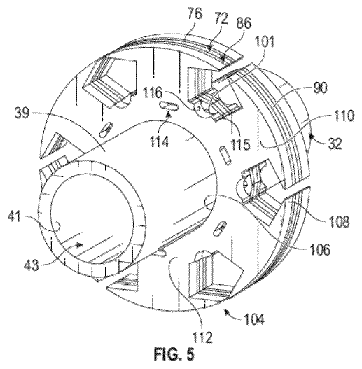

A third lamination portion 105, in accordance with a non-limiting example, is shown in FIG. 5. Third lamination portion 105 includes a third inner surface portion 106 and a third outer surface portion 108 that defines a third plurality of tooth elements 110. Tooth elements 110 are joined by a third web portion 112. A third passage portion 114 is defined in third web portion 112 at each of the plurality of tooth elements 110. In addition, third web portion 112 includes a radial outer surface 115 that extends between adjacent tooth elements 110. A scallop region 116 is formed in radial outer surface 115 so as to expose outer edge 101 of second passage portion 96. In this way, fluid passing into first passage portion 82 may flow into second passage portion 96 and a first portion of the fluid may pass from outer edge 101 into each channel 66 via scallop region 116 and a second portion of the fluid may pass through inner end 102 and into third passage portion 114. Thus, second passage portion 96 divides cooling circuit 68 into the first and second circuit portions.

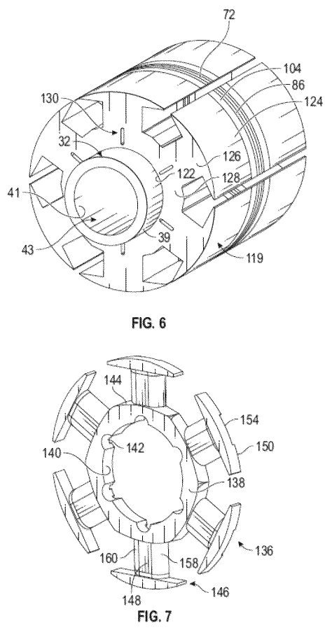

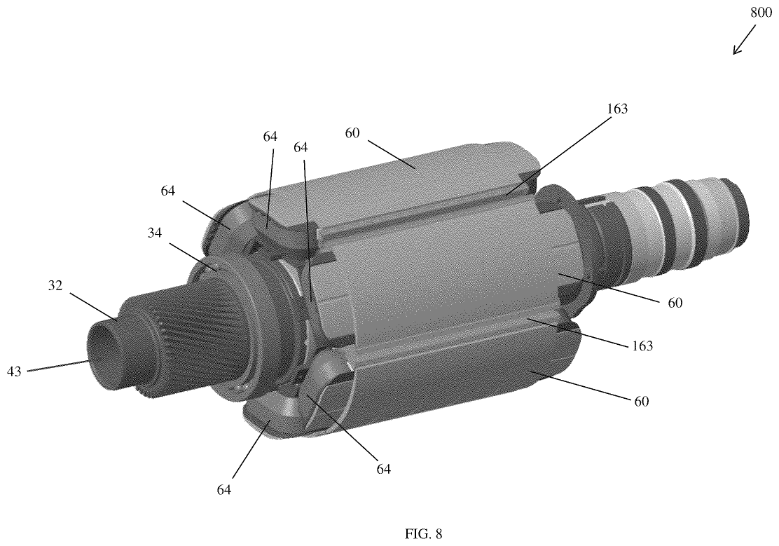

A fourth lamination portion 119, in accordance with a non-limiting example, is shown in FIG. 6. Fourth lamination portion 119 is positioned against third lamination portion 104 and includes a fourth inner surface portion 122 and a fourth outer surface portion 124 that defines a plurality of tooth elements 126. Tooth elements 126 are joined by a fourth web portion 128. Fourth lamination portion 119 includes a fourth passage portion 130 that is positioned on fourth web portion 128 at each tooth element 126. Fourth passage portion extends radially along fourth web portion 128 and fluidically connects with third passage portion 114 forming second circuit portion of cooling circuit 68 that extends from each third lamination portion 104 axially along laminations 54.

In a non-limiting example, an end turn insulator 136 (FIG. 1) is mounted to fourth lamination portions 119 at each axial end (not separately labeled) of laminations 54. End turn insulator 136 includes a central web 138 having an inner surface section 140 including a plurality of recesses 142. Recesses 142 may be arranged to accommodate fasteners (not shown) that join laminations 54. End turn insulator 136 also includes an outer surface section 144 from which extends a plurality of teeth supports 146 that provide structural support to rotor teeth 60. Each of the plurality of tooth supports 146 includes a first surface 148 that may be an axially outwardly facing surface and a second surface 150 that may be an axially inwardly facing surface.

In a non-limiting example, second surface 150 includes a channel 154 that directs coolant, flowing from fourth passage portion 130 radially outwardly onto first end turn 24 and second end turn 26. In a non-limiting example, first surface 148 includes a first angled surface 158 and a second angled surface 160 that help guide and support the one of the plurality of field windings 64 extending about each of the plurality of rotor teeth 60. Thus, not only do end turn insulators 136 support the plurality of laminations 54 but also provide a guide and insulator for each field winding 64 and also form part of the cooling circuit 68. Moreover, end turn insulators 136 may be employed to establish a desired rotational balance for wound field rotor 30.

In a non-limiting example, wound field rotor 30 also includes a plurality of field separators, one of which is indicated at 163 in FIGS. 1 and 2. Field separator 163 extends between adjacent ones of the plurality of rotor teeth 60 and bridge each channel 66. Field separator 163 include a generally v-shaped cross-section and are made from a compliant or non compliant material. Each field separator 163 includes a first leg 167 that engages with one of the plurality of rotor teeth 60 and a second leg 169 that engages with an adjacent one of the plurality of rotor teeth 60. In a non-limiting example, field separator 163 may flex as torque is generated by wound field rotor 30. In this manner, Field separator 163 may retain coolant in each channel 66 but also accommodate some leakage that flings coolant onto stator 20 to provide additional cooling.

FIG. 8 is a perspective view 800 of the wound field rotor 30, in an illustrative embodiment. The wound field rotor 30 includes a shaft 32 that extends along a longitudinal axis of the electrical machine or motor. The shaft 32 includes a coolant flow path 43 along the longitudinal axis. The laminations (i.e., first lamination portion 72, second lamination portion 86, third lamination portion 105, and fourth lamination portion 119) surround the outer surface of the shaft 32, thereby creating rotor teeth 60. A first bearing 34 and a second bearing 36 secures the shaft 32 to the housing 12. Field windings 64 wind around the rotor teeth 60 to form coil loops, with one side of a coil loop passing through an axial channel on one side of a rotor tooth and another side of the coil loop passes through an adjacent axial channel. Thus, each axial channel includes loops from two adjacent field windings 64. A field separator 163 fills in a gap between adjacent teeth at the outer surface of the laminations and extends readily inward to separate adjacent field windings from each other, as well as to maintain the structure of the field windings during rotation of the wound field rotor 30.

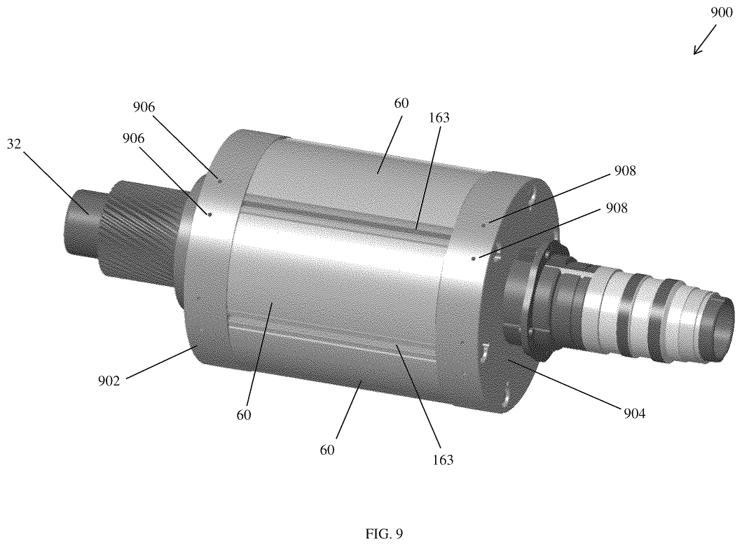

FIG. 9 is a perspective view 900 of the rotor of FIG. 8 with balance rings for securing the rotor. A first balance ring 902 is placed over the rotor teeth 60 at a first end of the rotor. A second balance ring 904 is placed over the rotor teeth 60 at a second end of the rotor. The first balance ring 902 includes escape holes 906 that are located on either side of the field separator 163 when the first balance ring 902 is assembled over the rotor teeth 60. Escape holes 906 pass through the first balance ring 902 from an interior of the rotor to the exterior of the rotor. Similarly, the second balance ring 904 includes escape holes 908 that are located on either side of the field separator 163 when the second balance ring 904 is assembled over the rotor teeth 60. Escape holes 908 pass through the second balance ring 904 from the interior of the rotor to the exterior of the rotor. Escape holes can be oriented a radial direction.

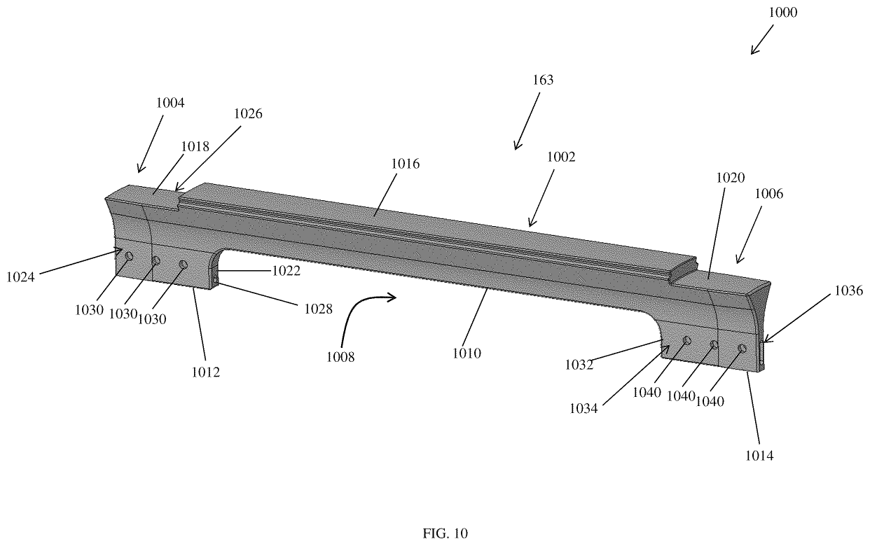

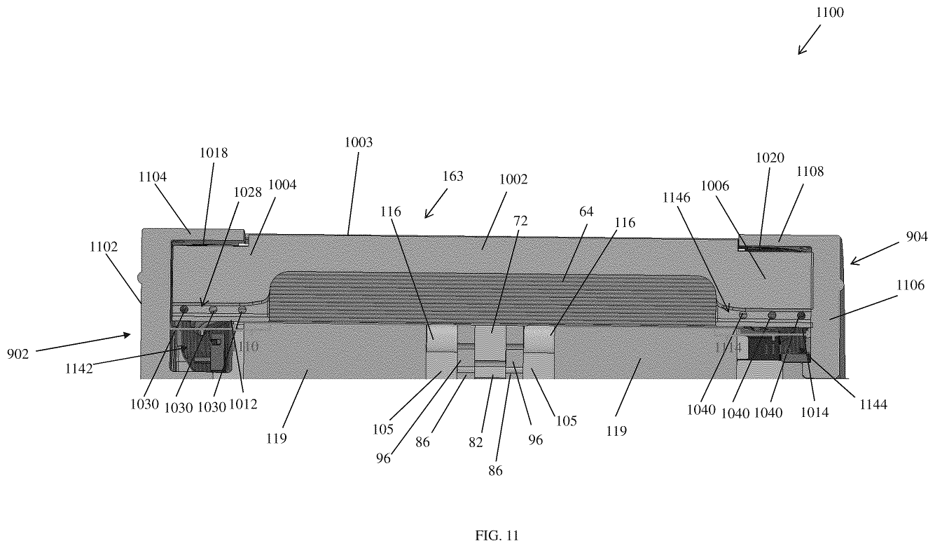

FIG. 10 is a perspective view 1000 of the field separator 163, in an illustrative embodiment. The field separator 163 includes a axially extending rail 1002 supported at a first end by a first post 1004 and at a second end by a second post 1006. The rail 1002 includes an arch 1008 that raises a lower surface 1010 of the rail above a bottom surface 1012 of the first post 1004 and a bottom surface 1014 of the second post 1006. The rail 1002 includes a radially outward rail surface 1016. The first post 1004 includes a first outer post surface 1018 on its radially outward side and the second post 1006 includes a second outer post surface 1020 on its radially outward side.

The first post 1004 includes a body having a axially inner surface 1022, a first circumferentially facing surface 1024 and a second circumferentially facing surface 1026 opposite the first circumferentially facing surface 1024. A passage passes through the first post 1004 from the axially inner surface 1022 to at least one of the first circumferentially facing surface 1024 and the second circumferentially facing surface 1026. In an embodiment, the passage includes at least one axially extending passage (indicated by opening 1028) that passes into the body of the first post 1004 from the axially inner surface 1022 and at least one circumferentially extending passage (indicated by openings 1030) that passes through the body of the first post 1004 from the first circumferentially facing surface 1024 to the second circumferentially facing surface 1026. The at least one axially extending passage intersects the at least one circumferentially extending passage within the body of the first post 1004. In an embodiment, the at least one axially extending passage includes a single axially extending passage and the at least one circumferentially extending passage includes three circumferentially extending passage, each of which intersects the single axially extending passage. The three circumferentially extending passages can have a same size or same radius. However, in alternate embodiments, the circumferentially extending passages can have different sizes or different radii.

Similarly, the second post 1006 includes a body having an axially inner surface 1032, a first circumferentially facing surface 1034 and a second circumferentially facing surface 1036 opposite the first circumferentially facing surface 1034. A passage passes through the second post 1006 from the axially inner surface 1032 to at least one of the first circumferentially facing surface 1034 and the second circumferentially facing surface 1036. In an embodiment, the passage includes at least one axially extending passage (shown in FIG. 11) that passes into the body of the second post 1006 from the axially inner surface 1032 and at least one circumferentially extending passage (indicated by openings 1040) that passes through the body of the second post 1006 from the first circumferentially facing surface 1034 to the second circumferentially facing surface 1036. The at least one axially extending passage intersects the at least one circumferentially extending passage within the body of the second post 1006. In an embodiment, the at least one axially extending passage includes one axially extending passage and the at least one circumferentially extending passage includes three circumferentially extending passage, each of which intersects the single axially extending passage.

The field separator 163 can be made of a material suitable to design specifications. Exemplary materials include such as aluminum, steel, plastic, etc. Steel and aluminum can be selected for improved heat conductance, while plastic can be selected for improved insulation. In other embodiments, the field separator 163 can be made of a metal material which is coated with an insulating material.

In an alternate embodiment, the field separator 163 can have ribs that extend radially inward (into the arch 1008) to hold the field wires in place. In addition, the coils can be varnished. Varnishing the coils helps retain the field separator 163 to the shaft 32. The varnish can also act as a seal between the field separator 163 and the laminations, thereby preventing oil from escaping into an air gap.

FIG. 11 shows a longitudinal cross-sectional view 1100 of the rotor passes through the field separator 163. The rail 1002 is placed in between adjacent field windings 64. The first post 1004 is supported at the first end between the fourth lamination portion 119 (at the bottom surface 1012) and the first balance ring 902 (at the first outer post surface 1018). The first balance ring 902 includes an end cap 1102 and a lip 1104. The lip 1104 extends axially over the first outer post surface 1018 to secure the field separator 163 at the first end. A first portion 1110 of the first post 1004 is supported by the fourth lamination portion 119. A second portion 1112 of the first post 1004 is unsupported by the fourth lamination portion 119 and is cantilevered over a first side channel 1142 at the first end of the rotor. The first side channel 1142 extends circumferentially around the rotor shaft at the end of the rotor.

Similarly, the second post 1006 is supported at the first end between the fourth lamination portion 119 (at the bottom surface 1014) and the second balance ring 904 (at the second outer post surface 1020). The second balance ring 904 includes an end cap 1106 and a lip 1108. The lip 1108 extends axially over the second outer post surface 1020 of the second post 1006 to secure the field separator 163 at the second end. A first portion 1114 of the second post 1006 is supported by the fourth lamination portion 119. A second portion 1116 of the second post 1006 is unsupported by the fourth lamination portion 119 and is cantilevered over a second side channel 1144 at the second end of the rotor. The second side channel 1144 extends circumferentially around the rotor shaft at the end of the rotor. An axially extending passage 1146 for the second post 1106 is also shown in FIG. 11.

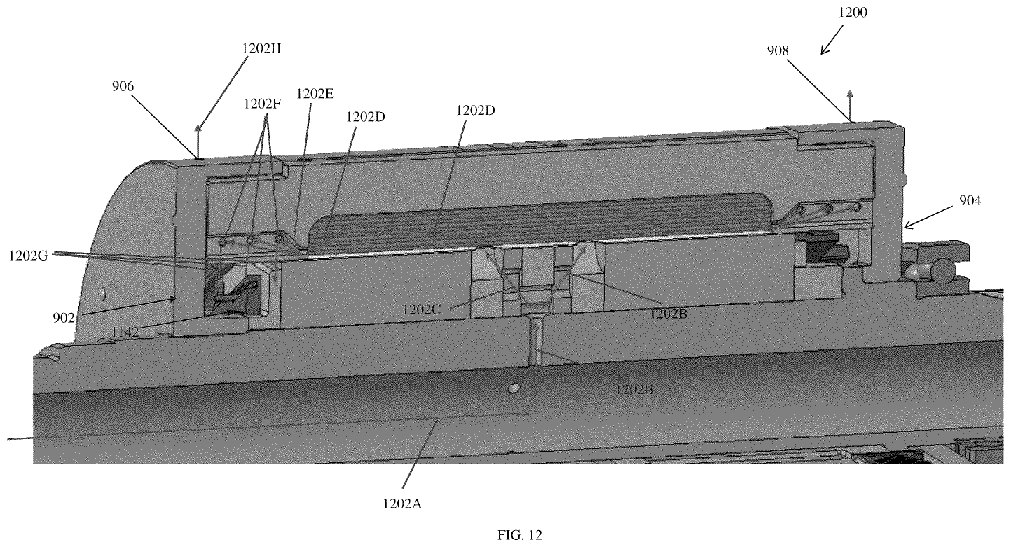

FIG. 12 shows a perspective view 1200 of the cross-section of the rotor, illustrating a flow circuit of coolant fluid through the rotor. The flow circuit includes a plurality of paths 1202A-H through which the coolant flows sequentially from one path to a subsequent path. A first path 1202A, allows the coolant to flow through the hollow bore in the shaft. A second path 1202B allows the coolant to flow out of the hollow bore to an outer surface of the shaft. A third path 1202C allows the coolant to from radially outward through the laminations, as shown by the lamination channels of FIGS. 3-5 near the axial center of the rotor. Upon exiting the laminations, the coolant flows into a channel between adjacent coils (path 1202D). The coolant is forced outwards by the centrifugal force of the spinning rotor and consequently fills up the arch 1008 in the field separator until it can be discharged at two axial ends of the coils into the openings of the axially extending passages in the first post 1004 and the second post 1006. The axially extending passages are close to the laminations (e.g., fourth lamination portion 119).

Path 1202E shows the flow of coolant in the first post 1004. As it passes through the first axially extending passage into the at least one circumferentially extending passage. Path 1202F allows the coolant to exit the circumferentially extending passage(s). The circumferentially extending holes discharge the fluid onto the end turn 24 of the field windings. The fluid then can follow path 1202G to fill up the first side channel 1142 created by the first balance ring 902. Path 1202G also allows flow of fluid radially outward, especially during rotation of the rotor. Path 1202H allows the fluid to flow out of the rotor through the escape holes 906 in the lip 1104 of the first balance ring 902. The escaping fluid is consequently sprayed onto the stator. A similar flow circuit can be used for fluid that flows to the second post 1006, through the axially extending passage 1146 in the second post and into a second side channel 1144. From the second side channel 114, the fluid exits the rotor via escape holes 908 in the second balance ring 904 to be sprayed onto the stator.

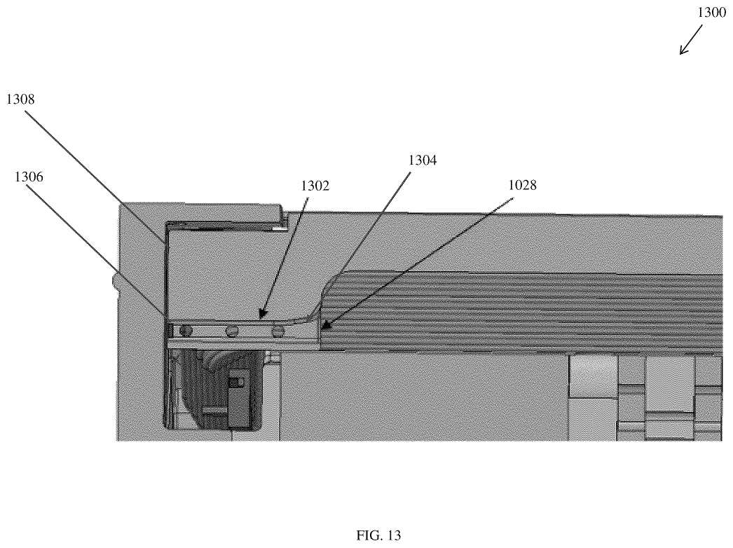

FIG. 13 shows an expanded view 1300 of a cross-section of the first post 1004 in a first embodiment. The expanded view 1300 shows an axially extending passage 1302 extending from opening 1028 at the axially inner surface 1022 of the first post 1004. The opening 1028 has a selected size or selected radius. The radius of the opening 1028 of the axially extending hole can be selected to reduce fluid turbulence. The axially extending passage 1302 extends from the opening 1028 to the outer end of the first post 1004. The axially extending passage 1302 decreases in flow cross-section in a narrowing section 1304 next to the opening 1208. The axially extending passage 1302 extends to an exit hole 1306 at an axially outer surface 1308 of the first post. The exit hole 1306 can be sealed or closed if desired. In one embodiment, the exit hole 1306 is sealed by applying epoxy to the field separator at the exit hole 1306. In another embodiment, the opening can be sealing by having the first balance ring 902 located as close as possible to the exit hole 1306. The second post 1006 can be similarly designed.

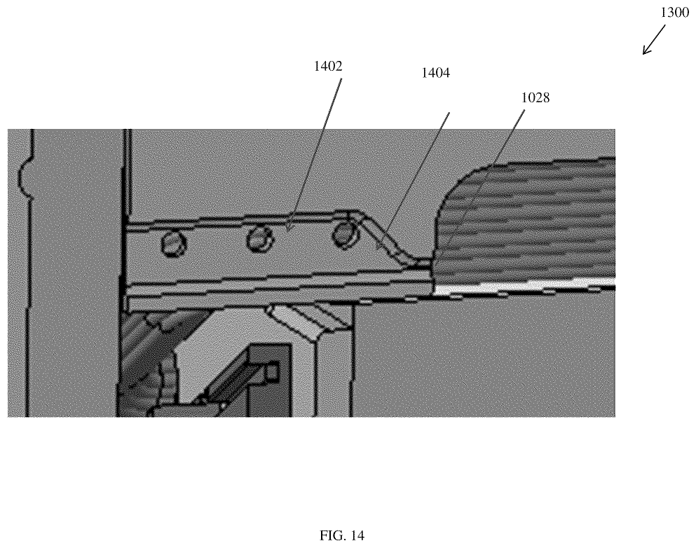

FIG. 14 shows an expanded view 1400 of a cross-section of the first post in a second embodiment. The expanded view 1400 shows an axially extending passage 1402 extending from opening 1028 at the axially inner surface 1022 of the first post 1004. The size of the opening 1028 in the second embodiment is less than the for the opening of the first embodiment. The axially extending passage 1402 extends from the opening 1028 to the outer end of the first post 1004. The axially extending passage 1402 increases in flow cross-section in an expanding section 1404 next to the opening 1208. The axially extending passage 1402 extends to an exit hole 1406 at a axially outer surface 1408 of the first post. The exit hole 1406 can be sealed or closed if desired, using any of the method disclosed above with respect to FIG. 13. The second post 1006 can be similarly designed.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A wound field rotor, comprising:
a shaft defining a longitudinal axis;
a plurality of laminations mounted to an outer surface of the shaft and including rotor teeth defining an axial channel along the longitudinal axis;
a plurality of field windings disposed in the axial channel; and
a field separator disposed in the axial channel to secure the plurality of field windings in the axial channel, the field separator including a post at an axial end of the field separator, the post having a passage therethrough to allow a fluid to flow out of the axial channel and into a side channel at an end of the rotor.

2. The wound field rotor of claim 1, wherein the passage includes an axially extending passage and at least one circumferentially extending passage, wherein the axially extending passage intersects the at least one circumferentially extending passage in a body of the post.

3. The wound field rotor of claim 2, wherein the at least one circumferentially extending passage includes three circumferentially extending passages.

4. The wound field rotor of claim 1, wherein the side channel extends circumferentially around a rotor shaft of the rotor.

5. The wound field rotor of claim 4, further comprising a balance ring that secures the post to at least one of the plurality of laminations, the balance ring having a lip extending axially over a radially outer surface of the post, the lip having an escape hole to allow the fluid from the side channel out of the rotor.

6. The wound field rotor of claim 2, wherein the axially extending passage includes one of: (i) a narrowing section adjacent an opening of the axially extending passage; and (ii) an expanding section adjacent the opening of the axially extending passage.

7. The wound field rotor of claim 1, wherein the post further comprising a first post at a first axially end of the field separator and a second post at a second axially end of the field separator.

8. An electrical machine, comprising:
a stator;
a rotor rotatable within the stator, the rotor comprising:
a shaft defining a longitudinal axis;
a plurality of laminations mounted to an outer surface of the shaft and including rotor teeth defining an axial channel extending along the longitudinal axis;
a plurality of field windings disposed in the axial channel; and
a field separator disposed in the axial channel to secure the plurality of field windings in the axial channel, the field separator including a post at an axial end of the field separator, the post having a passage therethrough to allow a fluid to flow out of the axial channel and into a side channel at an end of the rotor.

9. The electrical machine of claim 8, wherein the passage includes an axially extending passage and at least one circumferentially extending passage, wherein the axially extending passage intersects the at least one circumferentially extending passage in a body of the post.

10. The electrical machine of claim 9, wherein the at least one circumferentially extending passage includes three circumferentially extending passages.

11. The electrical machine of claim 8, wherein the side channel extends circumferentially around a rotor shaft of the rotor.

12. The electrical machine of claim 11, further comprising a balance ring that secures the post to at least one of the plurality of laminations, the balance ring having a lip extending axially over a radially outer surface of the post, the lip having an escape hole to allow the fluid from the side channel out of the rotor.

13. The electrical machine of claim 9, wherein the axially extending passage includes one of: (i) a narrowing section adjacent an opening of the axially extending passage; and (ii) an expanding section adjacent the opening of the axially extending passage.

14. The electrical machine of claim 8, wherein the post further comprises a first post at a first axial end of the field separator and a second post at a second axial end of the field separator.

15. A method of operating an electrical machine, comprising:
flowing a coolant through a rotor of the electric machine, the rotor including:
a shaft defining a longitudinal axis;
a plurality of laminations mounted to an outer surface of the shaft and including rotor teeth defining an axial channel extending along the longitudinal axis;
a plurality of field windings disposed in the axial channel; and
a field separator disposed in the axial channel to secure the plurality of field windings in the axial channel, the field separator including a post at an axial end of the field separator, the post having a passage therethrough to allow the coolant to flow out of the axial channel and into a side channel at an end of the rotor.

16. The method of claim 15, wherein the passage includes an axially extending passage and at least one circumferentially extending passage, wherein the axially extending passage intersects the at least one circumferentially extending passage in a body of the post, further comprising flowing the fluid from the axial channel into the post via the axially extending passage and out of the post via the at least one circumferentially extending passage.

17. The method of claim 16, wherein the at least one circumferentially extending passage includes three circumferentially extending passages.

18. The method of claim 15, wherein the side channel extends circumferentially around a rotor shaft of the rotor.

19. The method of claim 18, wherein the rotor has a balance ring that secures the post to at least one of the plurality of laminations, the balance ring having a lip extending axially over a radially outer surface of the post, further comprising flowing the fluid through an escape hole in the lip to allow the fluid from the side channel out of the rotor.

20. The method of claim 16, wherein the axially extending passage includes one of: (i) a narrowing section adjacent an opening of the axially extending passage; and (ii) an expanding section adjacent the opening of the axially extending passage.
